(19) United States
(12) Patent Application Publication
(10) Pub. No.: US 2010/0320259 A1
(43) Pub. Date: Dec. 23, 2010

(54) Moulded part as well as use of such a moulded part

(75) Inventors: Gidy Henri Cor Geert Knoors, Nuenen (NL); Arnoldus Henricus Adrianus Verberne, Eindhoven (NL)

Correspondence Address: Rankin, Hill & Clark LLP, 23755 Lorain Road, Suite 200, North Olmsted, OH, 44070, US

(73) Assignee: HAYNEST B.V., Eindhoven (NL)

(21) Appl. No.: 12/796,369

(22) Filed: Jun. 8, 2010

(30) Foreign Application Priority Data
Jun. 11, 2009 (NL) 1037033

(51) Int. Cl. B65D 27/00; C08L 97/02; B32B 21/02

(52) U.S. Cl. 229/68.1; 106/162.5; 106/137.1; 106/164.01; 428/335; 428/336

(57) ABSTRACT

The present invention relates to a moulded part based on a fibrous carrier material of natural origin and a binder, wherein the carrier material is of natural origin and comprises fibres.

Another object of the present invention is to recycle biological, organic residual flows in a useful manner, wherein the biological residual flows are further processed into a moulded part, which moulded part, if considered waste, can be disposed of via the green waste container.

The present invention relates to a moulded part based on a fibrous carrier material of natural origin and a binder. The present invention further relates to the use of such a moulded part.

The moulded parts referred to in the introductory paragraph are known per se, in practice they are generally composed of materials originating from fossil raw materials, in particular oil. A special example in this regard is EPS (Expanded PolyStyrene), which is a plastic material and which is used on a large scale inter alia in packaging materials, for example for televisions, computers, washing machines, electronic equipment, bathroom fixtures, toys and the like.

German Offenlegungsschrift DE 100 12 686 discloses a biological packaging material made up of a biodegradable fibre material and a starch, which moulded part is further provided with a coating.

From WO 2007/047848 there is known a so-called composite material, in which leather fibres, binders, non-leather fibres and a resilient material are incorporated.

From European patent application EP 0 393 804 there is known a packaging material composed of recycled paper.

From German Offenlegungsschrift DE 1.95 37 959 there is known a resilient element made up of a core and an enveloping layer, which each consist of a different material. Said layer is composed of natural fibres, for example of vegetable origin or animal hairs, using a binder, for example latex.

From WO A 00/77304 there is known a shock-absorbing plate material composed of recycled paper.

German Offenlegungsschrift DE 198 02 087, U.S. patent application US 2007/000602 and Japanese publication JP 06 064662 disclose moulded parts based on recycled paper.

EPS is not biodegradable and does not decompose under the influence of sunlight. EPS is used in large quantities as a packaging material and, because of its large volume, cannot be recycled in a cost-effective manner at this moment. The materials composed of EPS are very voluminous and have a very low specific weight, so that separate collection and/or sorting of EPS is not attractive from an economic viewpoint.

EPS generally becomes available as a waste material at the end user's location. EPS-based packagings, in particular for televisions, washing machines, refrigerators and the like, among other products, do not form part of a household's waste on a daily basis. The end user will generally dispose of the EPS used as a packaging material in the grey waste container, which, on account of the voluminous nature of EPS, will soon be full.

The object of the present invention is thus to provide a moulded part which is biodegradable.

Another object of the present invention is to recycle biological, organic residual flows in a useful manner, which biological residual flows are further processed into a moulded part, which moulded part, if considered waste, can be disposed of via the green waste container.

Another object of the present invention is to provide a moulded part composed on the basis of organic residual flows, which moulded part can be used as a packaging material, wherein the specific properties required for packaging materials can be efficiently obtained by means of a correct selection of starting materials.

The moulded part as referred to in the introductory paragraph is characterised in that the fibres are obtained from natural vegetation.

One or more of the above objects can be accomplished by using such a carrier material. It is thus in particular desirable for the fibres to be obtained from natural vegetation, in which regard it is preferable if the vegetation is selected from the group consisting of grass, straw from cereal crops, coleseed, maize, bamboo, cane and hemp, or a combination of two or more of the above vegetation, i.e. natural products. Natural vegetation is generally used as a feed source in the cattle farming industry, but they are also processed as biofuels, in particular as far as coleseed is concerned. The vegetation to be used in the present invention is not processed as part of an industrial process but processed as harvested, possibly via one or more mechanical treatments for obtaining the desired fibre parameters, such as length, thickness and length distribution, and removing any undesirable contaminations. The phrase “industrial process” is understood to include chemical processes, such as reactions, dissolving, refining, etc.

With a view to realising an advantageous use of biological residual flows it is desirable that materials be used which so far have been regarded as waste. A special example of a suitable natural carrier material is roadside grass. In the Netherlands roadside grass is available in the spring and in the autumn, and according to Dutch law mown roadside grass is regarded as waste. Because of this qualification mown roadside grass is only used on a small scale in the (cattle) farming industry. In view of the large amounts of mown roadside grass that become available every year, think of about 400,000 tons (30% dry matter) of roadside grass annually, it is desirable that such a residual flow be usefully utilized, in which connection the present inventors have in particular found that the mown roadside grass can be used as a suitable carrier material in the present invention. Another preferred natural product is hay, viz. dried meadow grass.

To obtain a three-dimensional moulded part having the intended mechanical properties, the amount of carrier material preferably ranges between 70 and 99 wt. %, based on the total weight of the moulded product, more in particular, the amount of carrier material ranges between 90 and 99 wt. %, based on the total weight of the moulded product. For a special application, the amount of carrier material preferably ranges between 80 and 90 wt. %, based on the total weight of the moulded product. More in particular, the remaining amount preferably consists of a binder, resulting in a moulded part based on 80 wt. % carrier material and 20 wt. % binder, for example.

In addition to the aforesaid carrier material and the binder in the present moulded product, in certain embodiments the moulded product may comprise one or more additives selected from the group of pigments, flame retardants, UV stabilizers, fillers and aromatic substances. It should be noted in this regard, however, that the present moulded product is preferably composed of biodegradable materials, and that the use of synthetic fibres, such as polypropylene, polyethylene, nylon and polystyrene fibres should be minimized. More in particular, the present moulded product does not contain any of the aforesaid synthetic fibres. In addition to that it should be noted that the amount of fibres not obtained from vegetation must be minimal. More in particular, the amount of fibres obtained from paper should be at most 15 wt. %, preferably at most 10 wt. %, in particular at most 5 wt. %, based on the total weight of the moulded product. More in particular, the moulded product does not contain any such fibres.

The binder used in the present moulded part is preferably a binder of natural origin, in which connection binders based on cellulose, gelatin and sugar, or a combination thereof, can be mentioned. The present invention does not relate to the use of starch or of starch-derived compounds as binders.

The present inventors have found that the mechanical properties of the present biodegradable moulded part are important, in which connection in particular the elasticity modulus and the degree of energy absorption (energy dissipation) by the material are mentioned. The elasticity modulus indicates the stiffness of the material or the elasticity under load and is determined by the tension on the material and the elongation which the material undergoes as a result of the material being placed under tension. The degree of energy absorption indicates the amount of energy (work) being absorbed in the material as a result of the breaking of bonds and fibres in the structure of the material. The present moulded part can in fact only be loaded in compression (negative elongation). The term “elongation” as used herein is to be understood to include compression as well, are therefore.

The present inventors have therefore found that it is desirable for the density of the moulded part to range between 100 and 300 kg/m³, in particular between 120 and 200 kg/m³. If the density is less than the aforesaid lower limit, a weak material will be obtained, which material is not suitable for the intended use. If, on the other hand, the density is higher than the aforesaid upper limit, the mechanical properties, in particular the compressibility and open fibre structure of the material will be inadequate, which is undesirable.

The present inventors have furthermore found that it is desirable that at least 80% of the fibres used have an average fibre length of 10-100 mm, in particular 20-60 mm. If the average fibre length is less than the aforesaid lower limit, the moulded part will have inadequate mechanical properties. If the average fibre length is higher than the aforesaid upper limit, a moulded part will be obtained whose elasticity modulus and/or energy absorption are outside the desired range.

The present inventors have furthermore found that it desirable that at least 10% of the fibres used have a thickness of at least 2 mm, more preferably that 20-50% of the fibres used have a thickness of at least 2 mm. No changes in the mechanical properties are observed if more than 50% of the fibres used have a thickness of at least 2 mm.

The present inventors have furthermore found that it is desirable in certain embodiments for the amount of binder to range between 5 and 30 wt. %, in particular between 15 and 25 wt. %, whilst it may in addition be preferable if the aforesaid amount of binder ranges between 0.5 and 10 wt:%, preferably between 2 and 6 wt. %, based on the total weight of the moulded part, with the amount of binder being determined on the basis of the percentage of dry matter. If an amount of binder of less than the aforesaid lower limit is used, an inadequate bond between the carrier material and binder will be observed. If, on the other hand, an amount of binder of more than the aforesaid upper limit is used, an end product will be obtained whose mechanical properties do not meet the requirements of the intended use, in particular as a packaging material.

The present invention further relates to the use of a moulded part as described above as a shock-absorbing material, in which connection in particular the use as a packaging material can be mentioned. The present moulded part is in particular suitable for use as an envelope in the housing for electronic goods, in which case the envelope protects the products to be transported, for example household electronic goods or bathroom fittings, against external forces, for example during the manufacture and transport of the products. In other words, the present moulded part is in particular suitable for substituting the current packaging materials, which are usually made of EPS, for a biodegradable product, with the goods to be packaged generally being transported in cardboard boxes. Thus, both the packaging material and the box itself are biodegradable. In a specific embodiment, the present moulded part comprising fibres from natural vegetation and a binder is externally provided with one or more coatings, which coatings contain components that impart specific properties to the moulded part. Examples of this are water repellence, resistance against weather influences, print ability, dimensional stability, but also pigments and aromatic substances.

In a specific embodiment it is also desirable that the fibres used in the present moulded part be used in a specific orientation, for example by arranging the fibres parallel to each other in the moulded part. Thus a very high degree of stiffness is obtained in a specific direction, whilst in another direction the material will exhibit a lower degree of stiffness. It is furthermore also possible in a specific embodiment to construct the combination of carrier material and binder in such a manner in the moulded part that a so-called “open fibre or cell” structure is obtained, thereby realising a decrease of specific weight whilst retaining the stiffness of the material. Such embodiments also fall within the scope of the present invention. Within this framework the present inventors have found that the energy absorption takes place by the breaking of the adhesive bonds, brought about by the binder, between the fibres in the matrix structure of the moulded part, and by the bending and kinking of the aforesaid fibres. In a specific embodiment, the energy absorbing effect can also be realised by giving the moulded part a specific three-dimensional shape, which will deform and thus absorb energy upon being subjected to an overload. Special examples of such embodiments are thus: perforating the moulded parts, moulded parts having integrated crumple zones, orienting the fibres in one or more directions, resulting in an increased stiffness in specific directions.

The present invention will now be explained in more detail by means of a number of examples, in which connection it should be noted, however, that the present invention is by no means limited to such special examples.

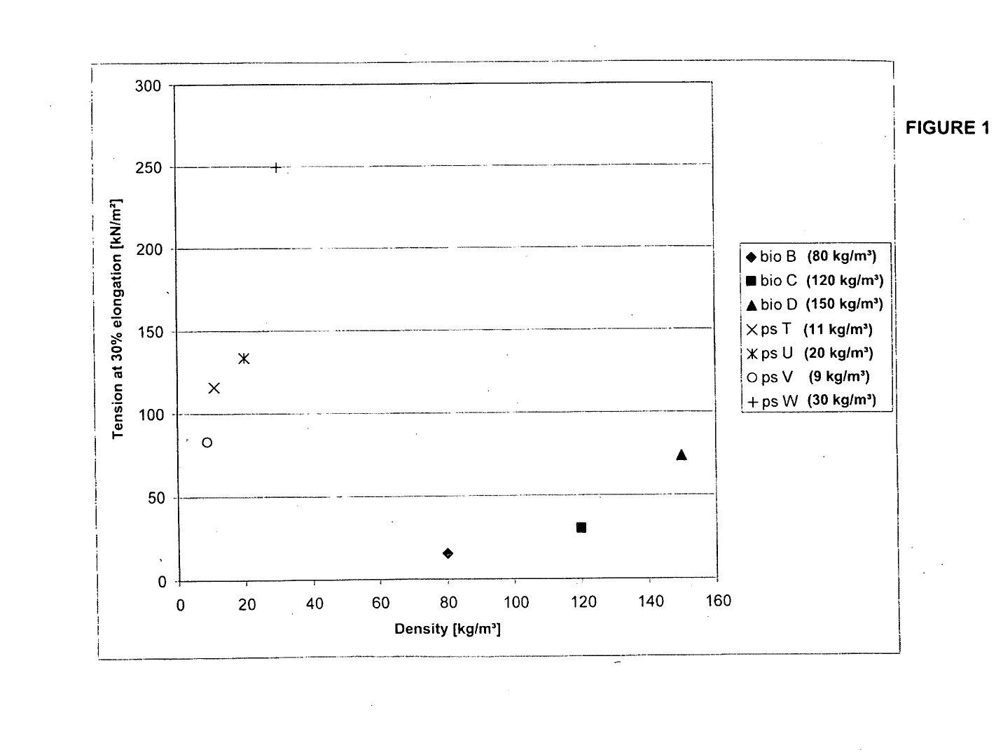

In FIG. 1 the tension at 30% elongation is shown as a function of the density.

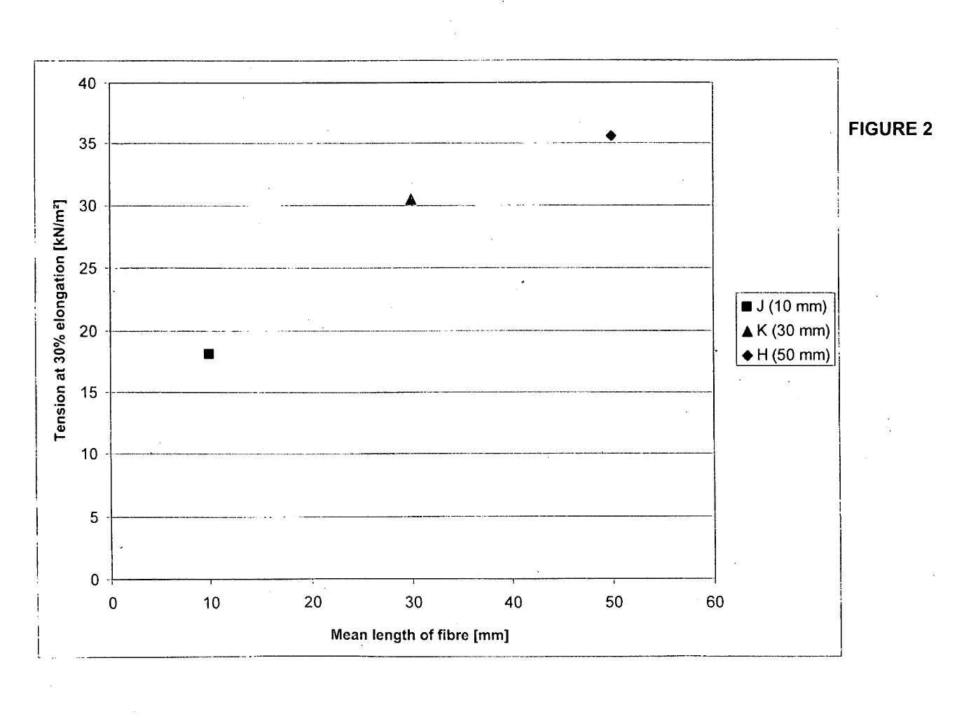

In FIG. 2 the tension at 30% elongation is shown as a function of the average fibre length.

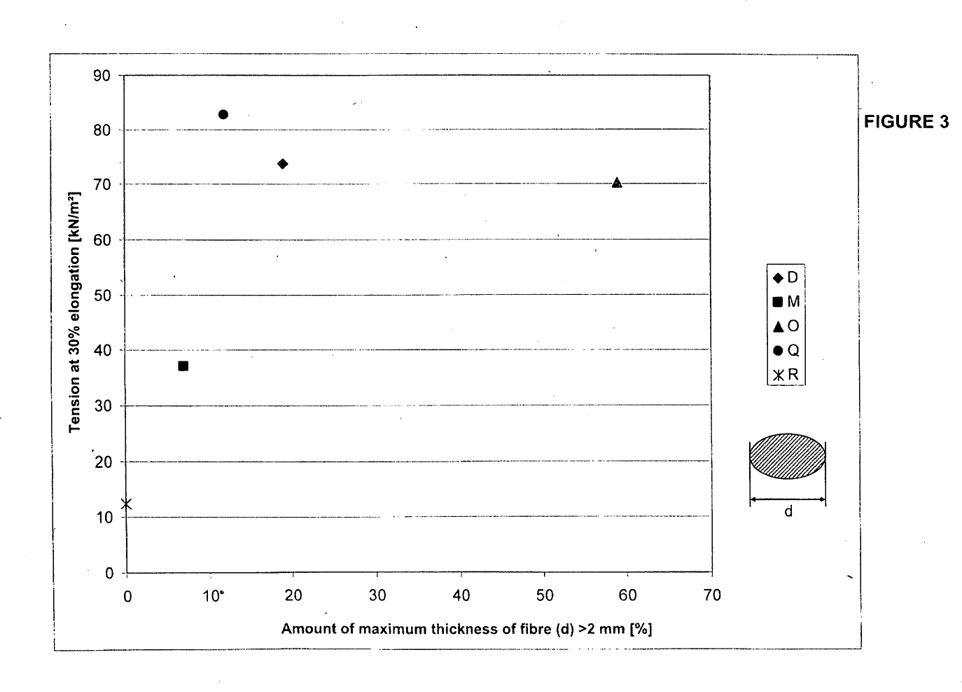

In FIG. 3 the tension at 30% elongation is shown as part of the maximum fibre thickness.

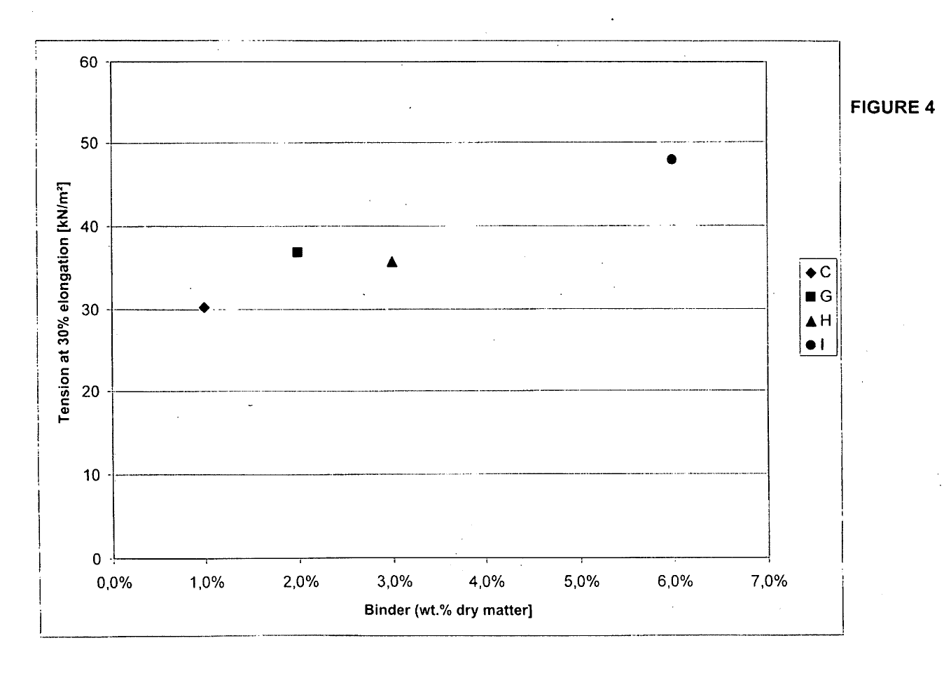

In FIG. 4 the tension at 30% elongation is shown as a function of the amount of binder.

### EXAMPLES

An amount of carrier material of natural origin, in particular hay, was mixed with a cellulose-type binder. Before the density and the influence thereof on the tension at 30% elongation was determined, a number of test samples in the form of cubes were produced, all having the same dimensions and thus also the same volume. Such cubes are made up of a fibrous carrier material of natural origin, mixed with the binder, resulting in a compact, airy structure.

FIG. 1 clearly shows that in order to obtain a minimum tension of 25 kN/m², measured at 30% elongation, a density of at least 100 kg/m³ is desirable. When the density is decreased to a value below 100 kg/m³, an undesirably low tension at 30% elongation is observed. When the density is further increased to a value above 300 kg/m³, which value is not shown in FIG. 1, a moulded part is obtained which exhibits inadequate elastic properties, which is not desirable, therefore. By way of illustration, FIG. 1 also shows moulded parts based on commercial EPS.

In FIG. 2 the influence of the average fibre length as a function of the tension at 30% elongation is graphically shown, in which regard the present inventors have found that it is desirable that at least 80% of the fibres used have an average fibre length of 10-100 mm, in particular 20-60 mm. In the present example, the fibre length has been varied by shortening commercially available fibres, for example by grinding and screening. From FIG. 2 it is clear that the stiffness of a moulded part increases as the fibre length of the fibres of natural origin decreases. As more fibres are grouped together as a result of the reduction of the average fibre length of the fibres, and at a constant volume of the moulded part, a greater stiffness is obtained.

In FIG. 3 the influence of the fibre thickness on the tension at 30% elongation is graphically shown, in which connection it should be noted that the fibre thickness can be varied by using fibre materials of different origin, for example by using different types of hay or straw. The present inventors have found that if the part of the maximum fibre thickness increases to a value >2 mm, the stiffness of the moulded part will increase as well. It is therefore desirable that at least 10%, preferably 20-50%, of the fibres used have a thickness of at least 2 mm in order to obtain the desired value for the tension at 30% elongation.

In FIG. 4 the percentage of binder, as a mass percentage of dry matter, is schematically shown, the influence of which on the tension at 30% has been examined. Too low a percentage of binder results in a poor distribution thereof over the fibres, so that an inadequate bond for all fibres is realised.

The present inventors have furthermore found that too high a percentage of binder leads to a greater stiffness but not to a higher energy absorption. It should furthermore be noted in this regard that if the binder is distributed over the fibres and the whole has been processed into the desired moulded part, the binder must dry and cure. Said drying preferably takes place at a slightly elevated temperature, for example a temperature higher than 30° C., avoiding high temperatures, however, because of the fire hazard. The present method for producing the present moulded part comprises the steps of providing the fibres, possibly cutting the fibres to length, mixing the same with a binder, transferring the mixture obtained to a mould, possibly exerting a force on the mixture in the mould, drying the assembly of mould and contents and finally removing the moulded part thus obtained from the mould. Since the fibres are of natural origin, there is a possibility that one or more inevitable natural “contaminations”, such as other plants, in particular weeds, will be present besides the fibres. Undesirable elements such as stones, metals and the like, are preferably removed in advance, for example by screening, by using magnets or by wind sifting.

The present inventors are further of the opinion that the binder has a dual function, because the binder is absorbed by the fibre in liquid condition, thereby imparting greater stiffness to the fibre upon drying of the moulded part. The binder furthermore causes the fibres to bond together, thereby strengthening the structure of the moulded part and thus increasing the stiffness thereof. It is therefore desirable to use binder in an amount of 5-30 wt. %, preferably 15-25 wt. %, but in certain embodiments it is desirable to use binder in an amount of 0.5-10 wt. %, preferably 2-6 wt. %, based on the total weight of the moulded part.

1-18. (canceled)

19. A molded part based on a fibrous carrier material of natural origin and a binder, wherein fibers of said fibrous carrier material are obtained from natural vegetation.

20. A molded part according to claim 19, wherein the vegetation is selected from the group consisting of grass, straw from cereal crops, coleseed, maize, bamboo, cane and hemp, or a combination of two or more of the above.

21. A molded part according to claim 20 wherein dried grass is used as a natural vegetation.

22. A molded part according to claim 19, wherein the amount of carrier material ranges between T0 and 99 wt. %, based on the total weight of the molded part.

23. A molded part according to claim 22, wherein the amount of carrier material ranges between 90 and 99 wt.%, based on the total weight of the molded part.

24. A molded part according to claim 19, wherein the molded part comprises one or more additives selected from the group of pigments, flame retardants, UV stabilizers, fillers and aromatic substances.

25. A molded part according to claim 19, wherein the amount of binder ranges between 0.5 and 30 wt. % based on the total weight of the molded part.

26. A molded part according to claim 25, wherein the amount of binder ranges between 15 and 25 wt. %, based on the total weight of the molded part.

27. A molded part according to claim 19, wherein the binder is of natural origin.

28. A molded part according to claim 1 wherein the binder is on basis of cellulose,

29. A molded part according to claim 19, wherein the binder is n basis of sugar.

30. A molded part according to claim 19, wherein the binder is on basis of gelatin.

31. A molded part according to claim 19, wherein the density of the molded part nges between 100 and 300 kg/m³.

32. A molded part according to claim 31, wherein the density of the molded part ranges between 120 and 200 kg/m³.

33. A molded part according to claim 19, wherein at least 80 of the fibers used have an average fiber length of 10-100 mm.

34. A molded part according to claim 33 wherein at least 80% of the fibers used have an average fiber length of 20-60 mm.

35. A molded part according to claim 19, wherein at least 10% of the fibers used have a thickness of at least 2 mm.

36. A molded part according to claim 35 wherein at least 20-50% of the fibers used have a thickness of at least 2 mm.

37. A molded part according to claim 19, wherein the amount of binder ranges between 0.5 and 10 wt. % based on the total weight of the molded part.

38. A molded part according to claim 37 wherein the amount of binder ranges between 2 and 6 wt. % based on a total weight of the molded part.

39. Use of a molded part according to claim 19 as a shock-absorbing material or a packaging material.

40. A housing for electronic goods provided with an envelope, wherein a molded part according to claim 19 is used as the envelope.
